(19) United States
(12) Patent Application Publication
(10) Pub. No.: US 2017/0154299 A1
(43) Pub. Date: Jun. 1, 2017

(54) TASK MANAGEMENT METHOD, TERMINAL, AND NON-TRANSITORY COMPUTER-READABLE INFORMATION RECORDING MEDIUM

(71) Applicant: LINE Corporation, Tokyo (JP)

(72) Inventor: Atsushi KADOTANI, Fukuoka (JP)

(21) Appl. No.: 15/076,808

(22) Filed: Mar. 22, 2016

(30) Foreign Application Priority Data
Nov. 27, 2015 (JP) 2015-232146

(51) Int. Cl. G06Q 10/06

(52) U.S. Cl. CPC G06Q 10/063114

(57) ABSTRACT

A task management method, carried out by one or more processors, includes determining whether a message received from a first terminal includes predetermined information; generating a task it the message includes the predetermined information; transmitting information of the generated task to the first terminal and a second terminal that is a transmitting destination of the message; and receiving information. to update the task's state from the first terminal or the second terminal, and managing the task's state.

The present application is based. on and claims the benefit of priority of Japanese Priority Application No. 2015-232146, filed on Nov. 27, 2015, the entire contents of which are hereby incorporated. herein by reference.

### BACKGROUND

1. Technical Field

The present disclosure relates to a task management method, a terminal, and a non-transitory computer-readable information recording medium.

2. Description of the Related Art

Technology to manage users' tasks in such a manner that terminals of the users and an information processing apparatus (for example, a server) operate together has been widespread. A “task” means the contents of an action that a user performs on business or privately. For example, “to buy an article”, “to prepare for a conference”, or the like, is managed as a task.

For example, a task is managed in. such a manner that (i) a terminal receives a user's input for the task; (ii) the terminal sends information of the received contents to an information. processing apparatus; and (iii) the information processing apparatus displays the received contents of the task on the terminal, if necessary.

In this regard, the information processing apparatus may store information. of the generated task for being shared. by the members of a group (for example, a family) that is previously set, and manage the task's state.

Technology, in which a terminal automatically generates a task according to the contents that are input by a user, and so forth, has been proposed (for example, see Japanese Laid-Open Patent. Application NO. 2015-519838).

### SUMMARY

According to one aspect, a task management method is carried out by one or more processors, and includes determining whether a message received from a first terminal includes predetermined information; generating a task if the message includes the predetermined information; transmitting information of the generated task to the first terminal and a second terminal that is a transmitting destination of the message; and receiving information to update the task's state from the first terminal or the second terminal, and managing the task's state.

Other objects, features and advantages will become more apparent from the following detailed description when read in conjunction with the accompanying drawings.

### BRIEF DESCRIPTION OF THE DRAWINGS

FIG. 1 illustrates an example of a system configuration of an information processing system according to a first embodiment;

FIGS. 2A 2C, FIGS. 3A-3C and FIGS. 4A and 4B illustrate examples of display screen pages displayed on terminals according to the first embodiment;

FIG. 5 illustrates an example of a hardware configuration of a computer (i.e., an information processing apparatus 10) according to the first embodiment;

FIG. 6 illustrates an example of a hardware configuration of a terminal 20 according to the first embodiment;

FIG. 7 illustrates an example of a functional configuration according to the first embodiment;

FIG. 8 illustrates an example of a task management table according to the first embodiment;

FIG. 9 illustrates an example of an operation sequence according to the first embodiment;

FIG. 10 illustrates an example of a flowchart according to the first embodiment;

FIG. 11 illustrates another example of an operation sequence according to the first embodiment;

FIG. 12 illustrates yet another example of an operation sequence according to the first embodiment;

FIGS. 13A and 13B illustrate other examples of display screen pages displayed on the terminals according to the first embodiment;

FIGS. 14A-14E illustrate examples of display screen pages displayed on the terminals according to a second embodiment;

FIG. 15 illustrates an example of a task management table according to the second embodiment; and

FIG. 16 illustrates an example of an operation sequence according to the second embodiment.

### DETAILED DESCRIPTION OF EMBODIMENTS

in the above-described technology in the related art, it is possible to automatically generate a task, or share the task by members of a group that is previously set. However, in the related art, it is not possible to share an automatically generated task among any users who are performing communications. In many cases, a task required for plan management becomes apparent during communications among user terminals using chat messages or the like. It is desirable that, also in such a case, a task is shared by users in a real-time manner, and the task's state is shared by the users.

Thus, an object of the embodiments is to extract, as a task, the contents to be managed among terminals that are performing communications, share the task's state of the thus extracted task by the users of the terminals, and manage the task's state.

### First Embodiment

### Summary of First Embodiment

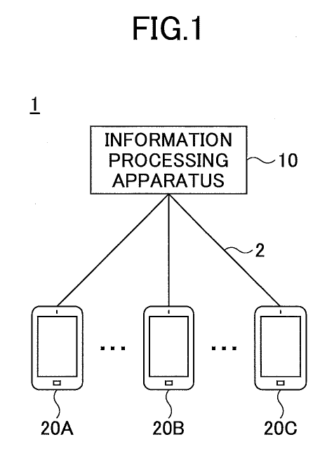

FIG. 1 illustrates an example of a system configuration of an information processing system 1 according to a first embodiment. The information processing system 1 includes an information processing apparatus 10, and a plurality of terminals 20A, 20B, 20C, and so forth (hereinafter, which may be generally referred to as “terminals 20”). The information processing apparatus 10 and the terminals 20 are connected via a network 2. The network 2 can be a wired network, a wireless network, or the like.

The information processing apparatus 10 is implemented by, for example, a server. The terminals 20 can be smart phones, tablet terminals, Personal Computers (PC), cell phones, game consoles, touch pads, electronic book readers, wearable terminals, or the like.

The information processing apparatus 10 provides a Social Network Service (SNS) to the users of the terminals 20. The users of the terminals 20 install applications of SNS in their terminals 20, and connect to the information processing apparatus 10. Thus, the users of the terminals 20 can receive provision of the SNS from the information processing apparatus 10.

Concerning the embodiments that will be described in detail, task management methods will now be described mainly for a case where a chat service among the users of the SNS is used. However, the task management methods according to the embodiments can be applied also to a case where emails are transmitted and received among users, a case where voice communication is performed among users, and so forth.

Each terminal 20 can use a web browser or the like, connect to the information processing apparatus 10, and receive provision of the SNS.

The information processing apparatus 10 provides various services that include a chat service and a Time-Line service among the users of the SNS. For example, the information processing apparatus 10 provides a remittance service between the SNS users. The above-mentioned “Time-Line” service is a service of displaying contents posted by the SNS users in a time-series manner.

The information processing apparatus 10 operates together with the terminals 20 to manage tasks. A “task” means the contents of an action that the user performs. Specific examples of a task includes “to buy an article”, “to attend a meeting”, and so forth.

Generally speaking, a task is registered in the terminals 20 and the information processing apparatus 10 by the user of the terminal 20, using a scheduler, a To-Do list function, a task list function, or the like, of the terminal 20. According to the first embodiment, in addition of these task registration ways, a task is registered in such a manner that, while a chat service is used among the terminals 20 of the users, if the information processing apparatus 10 determines, based on the contents included in a message of the chat service, to register a task, the task is registered based on the contents of the message. Details will be described later.

A task can be shared among a plurality of users. For example, if a task is registered concerning a family, the respective members of the family read the registered task, and update the registered contents. Also, a task can be shared among users who belong to any group that the users of terminals 20 set, for example, a chat group, or the like. Also, a task can be shared among users, who exchange messages using a chat service.

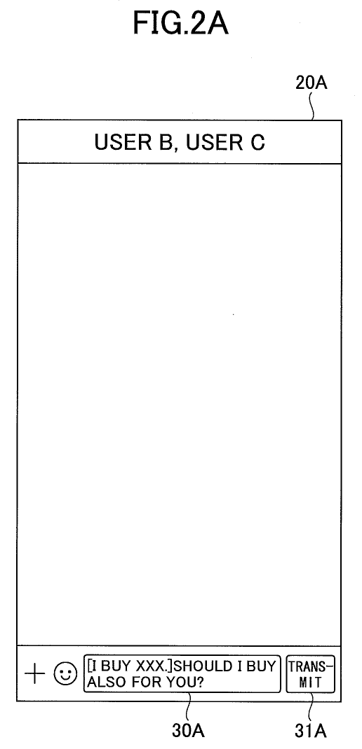

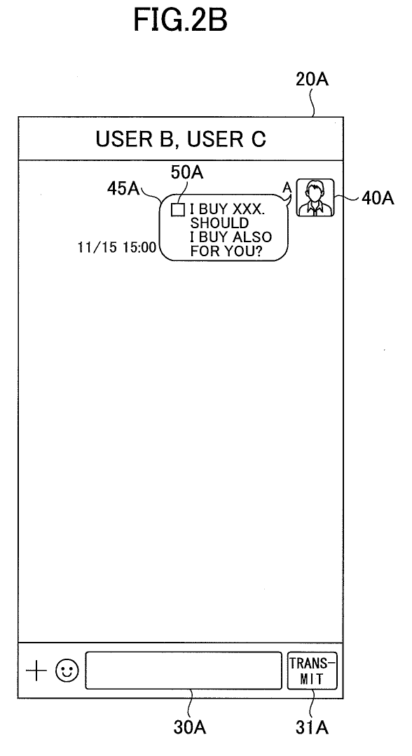

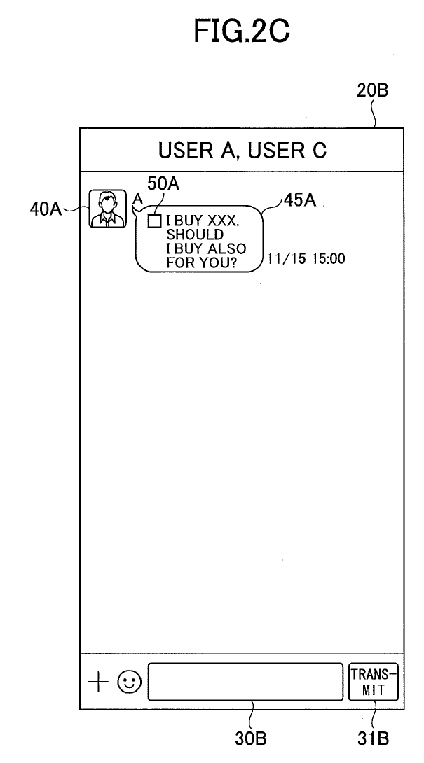

With reference to FIGS. 2A-2C, FIGS. 3A-3c, and FIGS. 4A and 4B, a task management method according to the first embodiment will be described. FIGS. 2A-2C illustrate display screen pages on terminals 20 according to the first embodiment.

According to the first embodiment, the information processing apparatus 10 determines whether predetermined information (i.e., a predetermined character(s), a predetermined sign(s), a predetermined code(s), a predetermined mark(s), or any combination thereof) is included in a message received from any terminal 20 in a chat message menu that displays chat messages transmitted and received among terminals 20. If the information processing apparatus 10 determines that a message includes a predetermined character(s), or the like, it stores the contents of the message as a task. Hereinafter, it is assumed, for example, that, if a message received from any terminal 20 includes brackets “[ ]”, the information processing apparatus 10 stores the character string included in brackets “[ ]” as a task.

FIGS. 2A-2C illustrate display contents of display screen pages displayed on the terminals 20 when chat messages are transmitted and received among the terminal 20A of the user A, the terminal 20B of the user B, and the terminal 20C of the user C.

FIG. 2A illustrates a state where, in the chat message menu, a message “[I buy XXX.] Should I buy also for you?” is input in the input field 30A of the terminal 20A of the user A. If the “transmit” button 31A is selected by the user A, the thus input message is transmitted from the terminal 20A to the terminal 20B of the user B and the terminal 20C of the user C, which the terminal 20A transmits chat messages to and receives chat messages from the information processing apparatus 10.

The information processing apparatus 10 determines that the character string included in brackets “[ ]” is present, and stores the character string “I buy XXX.” included in brackets “[ ]” as a task. The information processing apparatus 10 can store the character string included in. brackets “[ ]” as it is, or can change it to another character string suitable for storing as a task. For example, the information processing apparatus 10 can change the character string “I buy XXX.” to “purchase XXX”, and store it as a task.

The information processing apparatus 10 carries out such display control that the fact that the character string “I buy XXX.” is managed as a task can be known from display screen pages displayed at the terminals 20, which transmit chat messages to and receive chat messages from each other. Actually, as shown in FIGS. 2B and 2C, together with a check box 50A that indicates that the character string is stored as a task, the message 45A is displayed at the terminal 20.

FIG. 2B illustrates one example of a display screen page displayed at the terminal 20A. The message 45A transmitted by the terminal 20A itself is displayed in the display screen page together with the check box 50A.

FIG. 2C illustrates one example of a display screen page displayed at the terminal 20B. The message 45A transmitted by the terminal 20A is displayed in the display screen page displayed at the terminal 20B together with the check box 50A. Also in a display screen page displayed at the terminal 20C, the message 45A is displayed together with the check box 50A in the same way as the terminal 20B.

As described above, as a result of the message 45A being displayed on each of the terminals 20A, 20B, and 20C together with the check box 50A, the respective users of the terminals 20A, 20B and 20C can know that the contents included in the message 45A are managed as a task.

Addition of a task can be carried out not only by the terminal 20A of the user A but also by the user of any other terminal 20.

FIGS. 3A-3C illustrate examples of display screen pages of terminals 20 when a task is added.

FIG. 3A-3C illustrate display contents of display screen pages displayed on terminals 20 when chat messages are transmitted and received among the terminal 20A of the user A, the terminal 20B of the user B, and the terminal 20C of the user C.

FIG. 3A illustrates a state where, in the chat message menu, a message “at the same time [could you buy also YYY for me?]” is input to the input field 30B of the terminal 20B of the user B. If the “transmit” button 31B is selected, the thus input message is transmitted from the terminal 20B to the terminal. 20A and the terminal 20C, which the terminal B transmits chat messages to and receives chat messages from via the information processing apparatus 10.

The information processing apparatus 10 then determines that a character string included in brackets “[ ]” is present, and stores the character string included in brackets “[ ]”, i.e., “could you buy also YYY for me?” as a task. The information processing apparatus 10 displays a check box 50B on each of the terminals 20 (the terminal 20A, the terminal 20B, and the terminal 20C) such that the fact that the contents included in the message 453 is managed as a task can be known by the users of the terminals 20.

FIG. 3B illustrates one example of a display screen page displayed at the terminal 203. As shown, the message 45D that the terminal 20B transmits is displayed in the display screen page together with the check box 50B.

FIG. 3C illustrates one example of a display screen page displayed at the terminal 20A. As shown, the message 45D that the terminal 20B transmits is displayed in the display screen page of the terminal 20A together with the check box 50B. Also in the display screen page of the terminal 20C, the message 45D that the terminal 20B transmits is displayed in the display screen page together with the check box 50B, in the same way.

The information processing apparatus 10 stores a task list for each user, and displays it on a terminal 20 in response to a request from the terminal 20.

FIGS. 4A and 4B illustrate examples of display screen pages according to the first embodiment displayed on a terminal 20.

A terminal 20 receives an instruction from the user to receive a task management menu. FIG. 4A illustrates one example of a display screen page of the task management menu displayed at the terminal 20. If the terminal 20 receives an input performed by the user of selecting the “display task list” button 60, it acquires from the information processing apparatus 10 tasks concerning the user of the terminal 20. In more detail, if the “display not completed task” check box 61 is selected at the same time, the terminal 20 acquires information of the tasks having the tasks' states “not completed” from the information processing apparatus 10, and displays these tasks. If the “display already completed task” check box 62 is selected instead, the terminal 20 acquires information of the tasks having the tasks' states “completed” from the information processing apparatus 10, and displays these tasks. If both the check boxes 61 and 62 are selected instead, the terminal 20 acquires information of the tasks having the tasks' states “not completed” and the tasks having the tasks' states “completed” from the information processing apparatus 10, and displays these tasks.

In response to the terminal 20 thus acquiring information of tasks from the information processing apparatus 10, it displays a list of the tasks (a task list) as shown in FIG. 4B.

Each of the tasks included in the task list is displayed together with a check box 35A, 35B, 35C, 35D or 35E (hereinafter, which may be generally referred to as “check boxes 35”), information concerning the other users, who share the task, and a “check” button 34A, 34B, 34C, 34D or 34E (hereinafter, which may be generally referred to as ““check” buttons 34”).

The check box 35 provides a field for indicating whether the corresponding task's state is the state “completed” or the state “not completed”. If the check box 35 is checked, this means that the corresponding task is completed (the state “completed”). For example, the check boxes 35D and 35E are checked in. FIG. 4B. This means that the corresponding tasks are completed.

The above-mentioned “information concerning the other users” includes the user names, the users' icons 40B, 40C, 40E, and 40F (hereinafter, which. may be gene rally referred to as “icons 40”), or the like. In the example of FIG. 4B, the icons 40 of the users, who shares the corresponding tasks are, displayed together with the information of the tasks, respectively.

If a task's state is updated from the state “not completed” to the state “completed” in response to reception of an input from another user, who shares the task, the task is displayed in such. a manner that the user who updates the task's state can be known. For example, the icon 40 of the user, who performs an input to update the task's state, is checked. In FIG. 4B, such a state is illustrated. that. the task “prepare for conference at November 20” is completely updated by the user B, who is represented by the icon 40B.

The “check” button 34 is provided. for displaying a display screen page for the user of a terminal 20 to know details in which the task is registered. Actually, if a terminal 20 receives the user's input of selecting the “check” button 34 of a task included in the displayed task list, the information processing apparatus 10 acquires the message ID stored in association with the task, and displays the chat screen page that is displayed when the task is registered. The correspondences between tasks and message IDs can be stored. in terminals 20. In this case, a terminal 20 acquires a message ID stored in association with a corresponding task, and displays the chat screen page displayed. when the task is registered.

A task's state is displayed on the terminal 20 of users, who share the task in the same state.

Thus, each user can know details in which a task is registered.

Concerning the first embodiment described above, a task is extracted from a message when brackets “[ ]” are included in the message. However, another character(s), sign(s), stamp(s), or any combination thereof, can be used in The information processing apparatus 10 can determine that a task is included if a previously registered stamp is included in a message, and extract a task as characters included in a predetermined range (for example, on the same line as the stamp).

### Hardware Configuration

Next, the hardware configuration of each apparatus included in the information processing system 1 will be described.

### (1) Information Processing Apparatus

The information processing apparatus 10 has a configuration of a common computer.

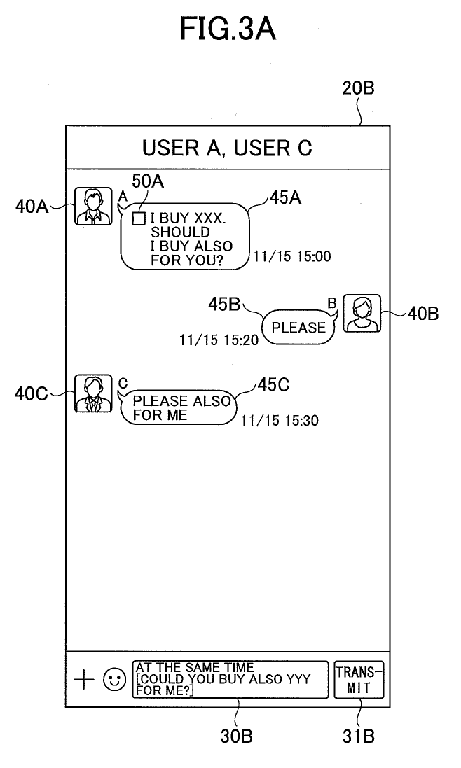

FIG. 5 illustrates an example of a hardware configuration of the computer (i.e., the information processing apparatus 10) according to the first embodiment.

As shown in FIG. 5, the computer 300 includes, for example, a Central Processing Unit (CPU) 301, a Random Access Memory (RAN) 302, a Read-Only Memory (RON) 303, a storage device 304, an input device 305, a display device 306, a communications InterFace (IF) 307, an external I/F 308, and an a bus 309.

The CPU 301 reads programs and/or data from a memory such as the ROM 303 or the storage device 304 to the RAM 302, carries out processes, and thus, controls the computer 300 and implements the functions thereof. The Ram 303 stores various programs and data such as a Basic Input/Output System (BIOS) executed when the computer 300 is started, settings of an Operating System (OS), and various settings. The RAM 302 is a volatile memory and stores programs and/or data temporarily. The storage device 304 has a large storage capacity and stores programs and/or data.

The input device 305 includes, for example, a keyboard, a mouse, and/or the like, and is used for the user to input various operation. signals. The display device 306 is, for example, a display, or the like, and displays processing results of the computer 300. Alternatively, the input device 305 and/or the display device 306 can be connected when they are used.

The communications I/F 307 is an interface for connecting the computer 300 to the network 2. The external I/F 308 is an interface for an external apparatus. The external apparatus can be an external storage medium 308a, or the like. Thus, the computer 300 can read information from and/or write information to the external storage medium 308a via the external I/F 308. Specific examples of the external storage medium 308a include, for example, various optical disks, various memory cards, and so forth.

As a result of the CPU 301 executing the programs stored in the ROM 303, and so forth, it can implement various functions of the information processing apparatus 10.

### (2) Terminal

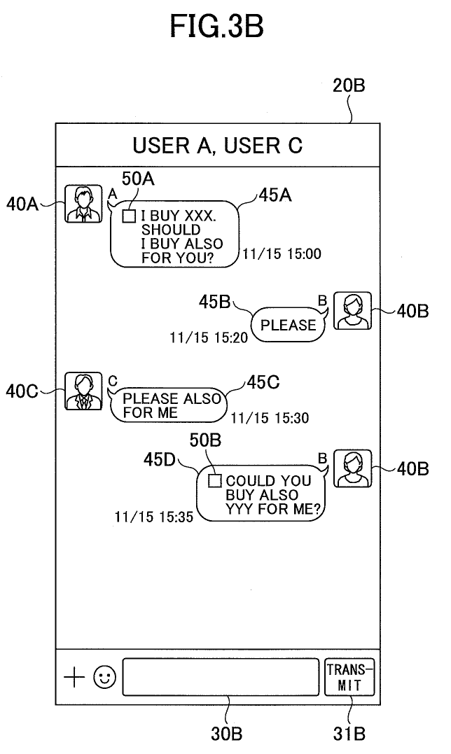

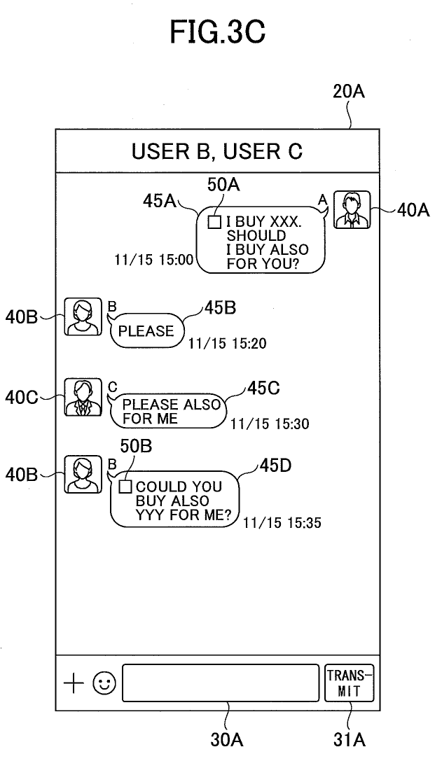

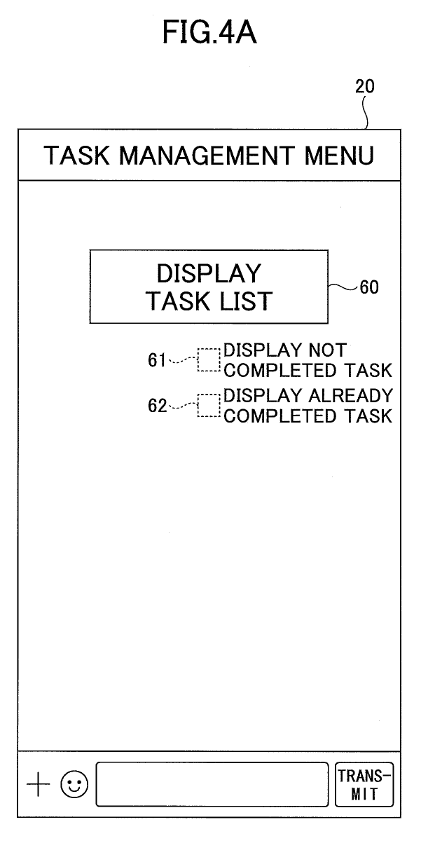

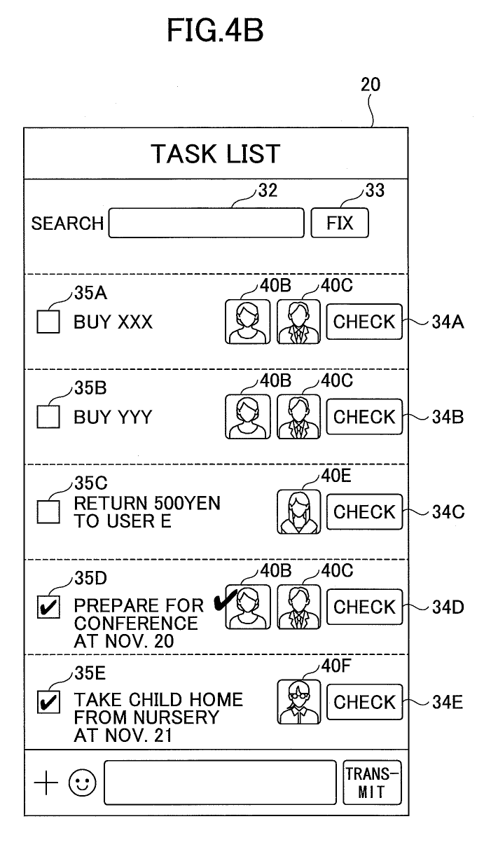

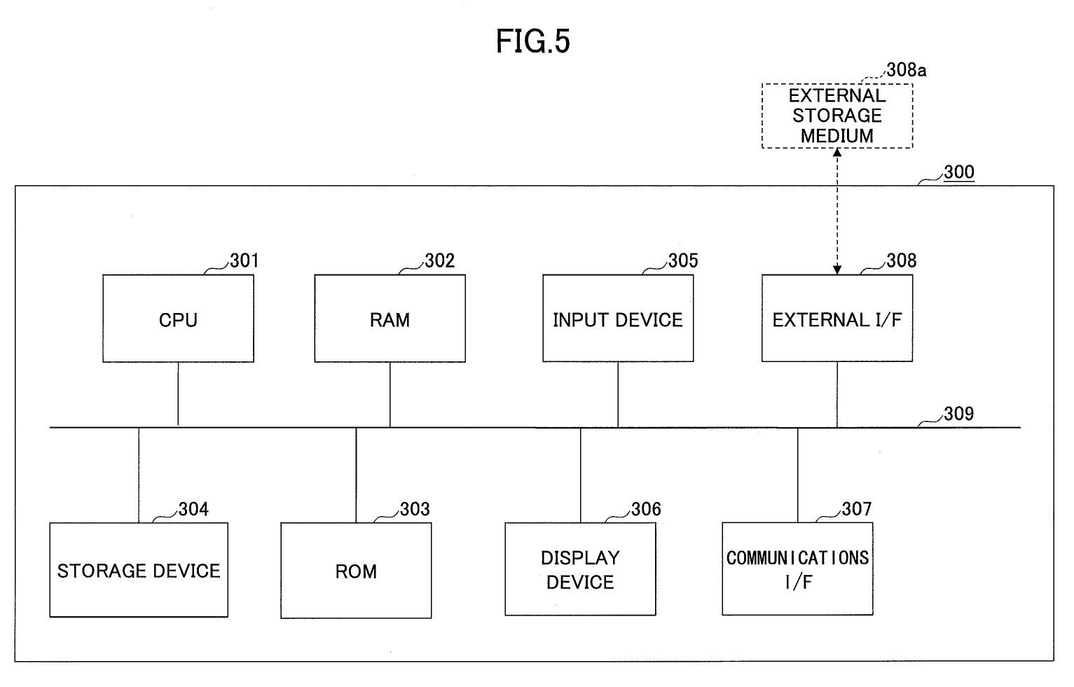

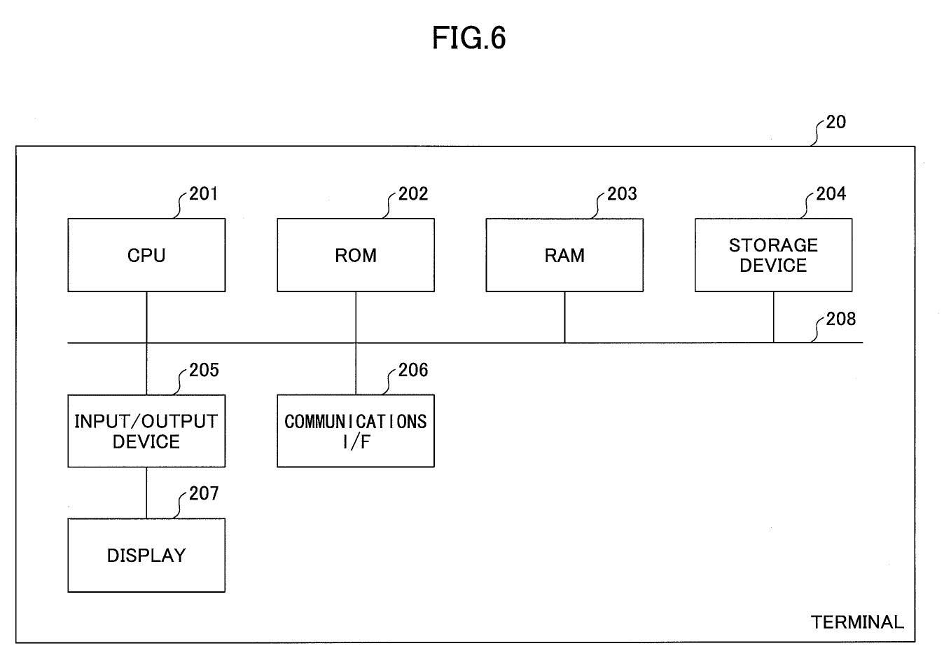

FIG. 6 illustrates an example of a hardware configuration of each terminal 20 according to the first embodiment.

Each terminal 20 includes a CPU 201, a ROM 202, a RAM 203, a storage device 204, an input/output device 205, a communications I/F 206, and a display 207 (a display device). The respective hardware elements of the terminal 20 are connected via a bus 208.

The storage device 204 stores various programs. The CPU 201 executes the programs stored in the storage device 204.

The ROM 202 is a nonvolatile memory. The ROM 202 stores various programs, data, and so forth, necessary for the CPU 201 to execute the various programs stored in the storage device 204.

The RAM 203 is a main storage such as a Dynamic Random Access Memory (DRAM), or a Static Random Access Memory (SRAM). The RAM 203 provides a work area in which the various programs are expanded when the CPU 201 executes the various programs.

The input/output device 205 includes an input device for inputting various instructions to the terminal 20, and an output device for outputting processing results of the terminal 20. The input/output device 205 is connected to the display 207. According to the first embodiment, the display 207 can be a touch reaction type display (i.e., a touch panel). The communications I/F 206 carries out communications between the terminal 20 and the information processing apparatus 10 via the network 2.

As a result of the CPU 201 executing the programs stored in the storage device 204, or the like, it can implement various functions of the terminal 20.

### Functional Configuration

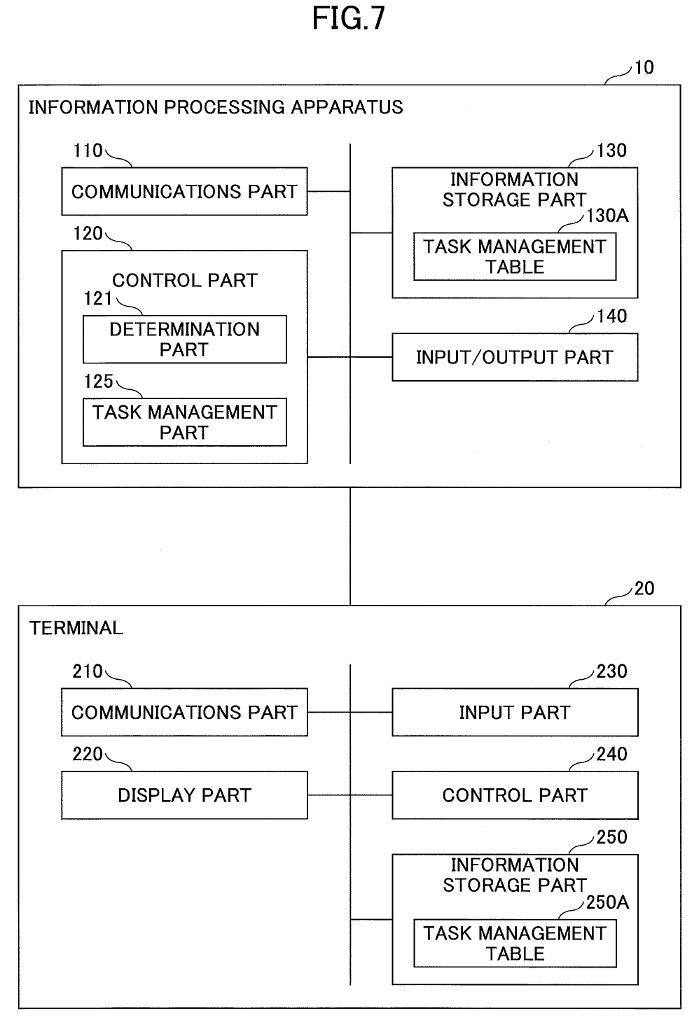

FIG. 7 illustrates an example of a functional configuration according to the first embodiment. With reference FIG. 7, the functional configurations of the information processing apparatus 10 and each terminal 20 will now be described.

### (1) Information Processing Apparatus

The information processing apparatus 10 includes a communications part 110, a control part 120, an information storage part 130, and an input/output part 140. The control part 120 includes a determination part 121 and a task management part 125.

The respective functional blocks operate together as follows. The communications part 110 receives a message from the terminal 20A. The determination part 121 determines whether the message includes the predetermined information. If the message includes the predetermined information, the task management part 125 generates a task. The communications part 110 transmits the generated task to the terminal 20A and the terminal 20B that is the transmitting destination of the message. If the communications part 110 receives an input from the terminal 20A or the terminal 20B, to update the task's state, the task management part 125 updates the task's state accordingly.

Next, the function of each functional block will be described.

The communications part 110 transmits various information to and receives various information from terminals 20. The communications part 110 receives a message from a terminal 20, and sends information of the received message to the control part 120. The communications part 110 transmits a message to a terminal 20 based on an instruction from the control part 120.

The control part 120 carries out various control operations concerning various functions of the information processing apparatus 10. The control part 120 includes the determination part 121 and the task management part 125. The determination part 121 determines whether a message received from a terminal 20 for another terminal 20 includes the predetermined information.

The “predetermined information” acts as a request to generate a task. If a message includes the predetermined information, the determination part 121 sends an instruction to the task management part 125 to generate a task.

In response to the instruction from the determination part 121, the task management part 125 generates a task. The task management part 125 determines the task's name based on the contents of the message. If the predetermined information indicates a part of the message, which is to be used as the task's name, the task management part 125 generates the task's name based on the predetermined information.

In the above-described example, brackets “[ ]” correspond to the predetermined information, and indicate that the character string included. in brackets “[ ]” are a part to be used as a task's name.

The task management part 125 gives an identifier (a task ID) to the generated task. Also, the task management part 125 stores various information concerning the task in the task management table 130A. The generate task is stored as a shared task to be shared by the user of the terminal 20, which transmits the message, and the user of the other terminal 20, for which the message is thus transmitted by the terminal 20. A “shared task” means a task shared by the users of a plurality of terminals 20. The various information thus stored in the task management table 130A will be described later.

If the communications part 110 receives an instruction from any one of the terminal 20 and the other terminal 20, who share the task, to change the task's state, the task management part 125 sends an instruction to update the task's state stored in the information storage part 130. Actually, the task management part 125 sends an instruction to change the task's state stored in the information storage part 130 from the state “not completed” to the state “completed”.

The information storage part 130 stores various information required for providing the SNS. The information storage part 130 stores the task management table 130A. Based on an instruction from the task management part 125, the information storage part 130 stores information concerning the generated task in the task management table 130A, and, when the task's state is updated, the information storage part 130 updates the information concerning the task stored in the task management table 130A. The task management table 130A. will be described later.

The input/output part 140 receives various inputs given to the information processing apparatus 10, and displays states of the information processing apparatus 10.

### (2) Task Management Table

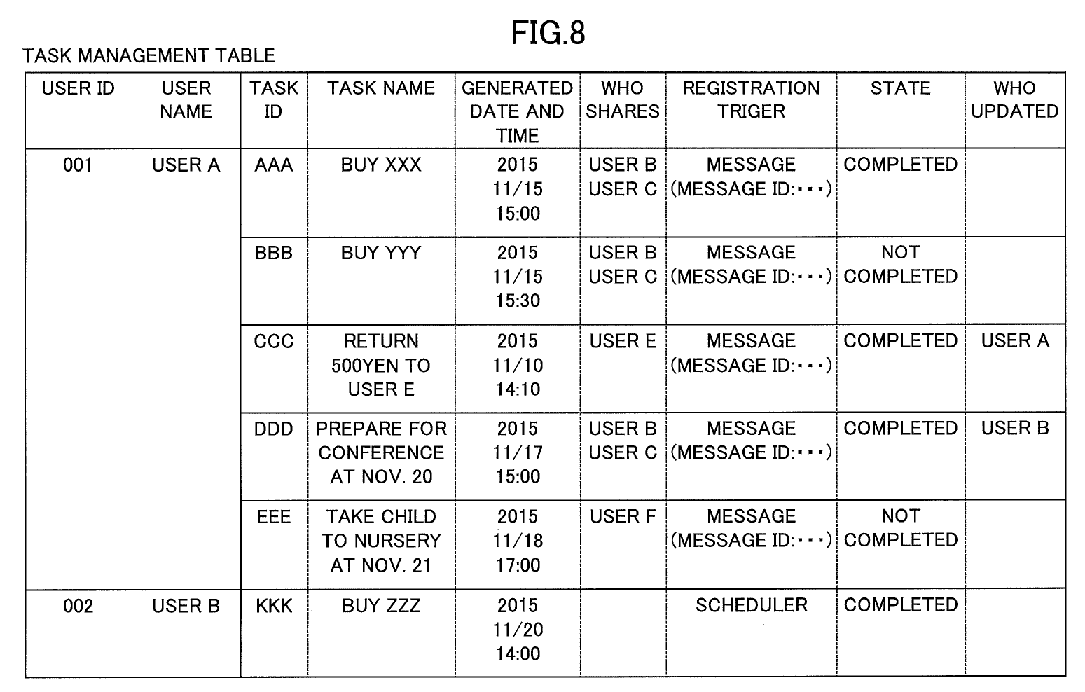

FIG. 8 illustrates an example of the task management table 130A according to the first embodiment. In the task management table 130A, information of tasks is stored for each user.

In response to the communications part 110 of the information processing apparatus 10 receiving a request to display a task list from the terminal 20A of the user A, the task management part 125 extracts the user A's tasks, i.e., the tasks associated as the user A's tasks from the task management table 130A. In the example of FIG. 8, the tasks having the task. IDs “AAA”, “BBB”, “CCC”, “DDD”, and “EEE” are extracted as the user A's tasks.

Information of each task is stored with the user ID, the user name, the task ID, the task name, the (task) generated date and time, the (user) who shares (the task), a registration trigger, the state, the (user) who updated (the task), and an attribute.

The user ID is an identifier for uniquely identifying the user in the SNS. The user name is the user's name registered in the SNS.

The task ID is an identifier for uniquely identifying the task in the SNS. The task management part 125 gives it. The task name is the task's name generated by the task management part 125. For example, a part or the corresponding message is set as the task name. Alternatively, a name generated based on a part of the corresponding message is set as the task name.

As the (task) generated date and time, the date and time, at which the task management part 125 generates the task is set. Alternatively, as the (task) generated date and time, the date and time, at which the terminal 20 transmits the corresponding message that includes the predetermined information can be set.

As the (user) who shares (the task), the name or the identifier of the user, who shares the task, is set. If the message that includes the predetermined information is transmitted to a plurality of destinations, the names or the identifies of the plurality of users are set as the (user) who shares (the task). For example, if the terminal 20A of the user A transmits a message that includes the predetermined information to the terminal 20B of the user B and the terminal 20C of the user C, the task is shared. by the user A, the user B, and the user C. Therefore, in the record of the user A in the task management able 130A, information of “user B” and “user C” is stored in the (user) who shares (the task) field for the task.

In the registration trigger field, information for identifying the message, based on which the task is generated, is stored. For example, the message ID that is the identifier of the message is stored. If a request to register the task is received from the terminal 20 of a user due to a function of a menu such as a scheduler, the menu such as the scheduler that is used to request to register the task is stored as the registration trigger field. FIG. 8 shows a case where, as an example, concerning the task ID “KKK”, the task is input in the scheduler menu of the terminal 20B of the user B, and as a result, the terminal 20B sends information of the task to the information processing apparatus 10.

In the state field, the task's state is stored. Actually, the state “completed” or the state “not completed” is set there.

In the (user) who updated field, the user name of the user who updated the task is stored. The task's state is updated as a result of any user, who shares the task, inputting corresponding information to his or her terminal 20, and the input contents being sent from the terminal 20 to the information processing apparatus 10. The task management table 130A can store the updated date and time.

### (3) Terminal

The terminal 20 includes a communications part 210, a display part 220, an input part 230, a control part 240, and an information storage part 250. The respective functional blocks of the terminal 20 operates together as follows. The control part 240 sends an instruction to the communications part 210 to generate and transmit a message that includes the predetermined information that indicates a request to generate a task for another terminal 20. In response to the instruction from the control part 240, the communications part 210 transmits the message to the information processing apparatus 10. Also, the communications part 210 receives information of a task that is generated based on the transmitted message and is shared with the other terminal 20, which is the transmitting destination of the message. Also, the communications part 210 receives the task's state that is updated as a result of an input being given to the other terminal, with which the task is shared, from the information processing apparatus 10.

Next, the function of each functional block will be described.

The communications part 210 transmits various information to and receives various information from the information processing apparatus 10. The communications part 210 receives an instruction from the control part 240, and transmits a message for another terminal 20 to the information processing apparatus 10. The communications part 210 receives a message for the terminal 20 from the information processing apparatus 10.

The display part 220 displays various information according to instructions from the control part 240. If a message transmitted by the terminal 20 or a message received from another terminal 20 includes the predetermined information, the display part 220 displays the message with a check box that indicate that the task is set.

If the communications part 210 receives a task list in response to the input part 230 receiving the corresponding request from the user, the display part 220 displays the task list. If a task's state is changed, the display part 220 displays the fact that the task's state is changed. The input part 230 receives an input from the user of the terminal 20, and sends the received contents to the control part 240. The input part 230 receives an input of a message that includes the predetermined that indicates a request to generate a task from the user of the terminal 20. The input part 230 receives a request to change a task's state from the user of the terminal 20. Also, from the user of the terminal 20, the input part 230 receives a request to acquire a task list.

The control part 240 carries out control operations concerning the respective functions of the terminal 20.

The information storage part 250 stores various information required when the user of the terminal 20 uses the SNS via the information processing apparatus 10. The information storage part 250 stores a task management table 250A. The task management table 250A stores information concerning tasks of the user of the terminal 20, concerning which the information. processing apparatus 10 sends information to the terminal 20.

The task management table 250A includes at least the task IDs and the task names concerning the user of the terminal 20. The task management table 250A can store the same items as those of the task management table 130A stored by the information processing apparatus 10, concerning the tasks of the user of the terminal 20.

### Operation Procedure

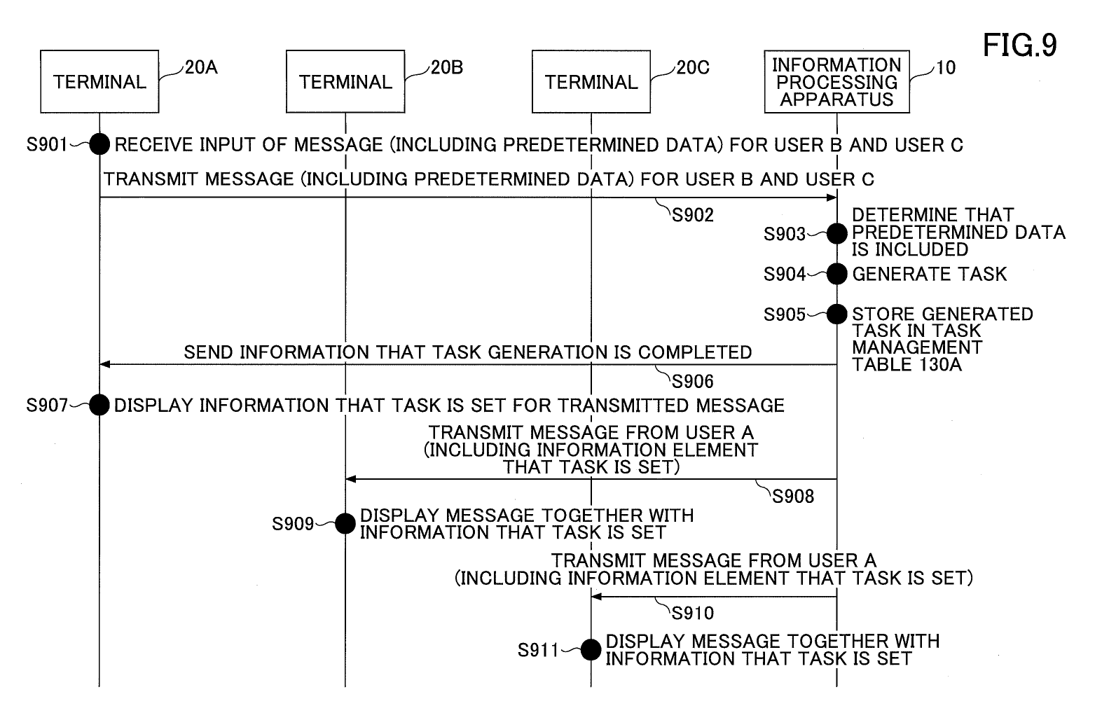

FIG. 9 illustrates an example of an operation sequence for sharing a task according to the first embodiment.

FIG. 9 illustrates operations carried out when, in a case where the user A, the user B and the user C belong to the same chat group, the terminal 20A of the user A transmits a message to the terminal 20B of the user B and the terminal 20C of the user C.

In step S901, the input part 230 of the terminal 20A receives an input of a message for the users B and C from the user A of the terminal 20A. The message includes the predetermined information that indicates a request to set a task.

In step S902, in response to the input part 230 receiving an instruction for transmission, the communications part 210 transmits the message to the information processing apparatus 10. The communications part 110 of the information processing apparatus 10 receives the message.

In step S903, the determination part 121 of the information processing apparatus 10 determines whether the received the message includes the predetermined information. In this case, the predetermined information is included there. Therefore, the determination part 121 sends an instruction to the task management part 125 to generate a task.

In step S904, the task management part 125 generates a task. If the predetermined information indicates a part of the message, which is to be used as a name of the task, the task management part 125 determines a name of the task based on the predetermined information.

In step S905, the task management part 125 sends an instruction to the information storage part 130 to store the thus generated information concerning the task in the task management table 130A. According to the instruction from the task management part 125, the information storage part 130 stores the information concerning the generated task in the task management table 130A. Actually, it adds the information of the generated task to respective task lists of the user A, the user B, and the user C. Each time when the information processing apparatus 10 receives a message that includes the predetermined information, it adds the information of the corresponding task to the respective task lists of the user who transmits the message and the users who are the transmitting destinations.

In the “task ID” field and the “task name” field of the task management table 130A, the task ID and the task name generated by the task management part 125 are set. In the “generated date and time” field, the date and time at which the information processing apparatus 10 receives the message from the terminal 20A is set. In the “who shares” field of the task list of the user A, the user B and the user C are set. In the “registration trigger” field, the message ID of the message received from of the terminal 20A is set. In the “state” field, the state “not completed” is set when the task is generated. If a subsequent task is present or the presence likelihood is high, information concerning the subsequent task can be set there. A “subsequent task” will be described later. Here, it is assumed that no subsequent task is set.

In step S906, the communications part 110 of the information processing apparatus 10 transmits information that the generation of the task for the received message is completed to the terminal 20A. The communications part 210 of the terminal 20 receives the transmitted information.

In step S907, in response to the control part 240 of the terminal 20A receiving the transmitted information, it displays, on the display part 220, the transmitted message together with a check box 50 that indicates that a task is set for the message.

In step S908, the communications part 110 of the information processing apparatus 10 transmits the message to the terminal 20B. The message includes an information element that indicates that a task is set. The terminal 20B receives the message.

In step S909, the terminal 20B displays the received message together with a check box 50 that indicates that a task is set for the message.

Steps S910 and S911 are the same as steps S908 and S909. Therefore, description thereof is omitted. Also in the terminal 20C, the same processes as those in the terminal 20B are carried out.

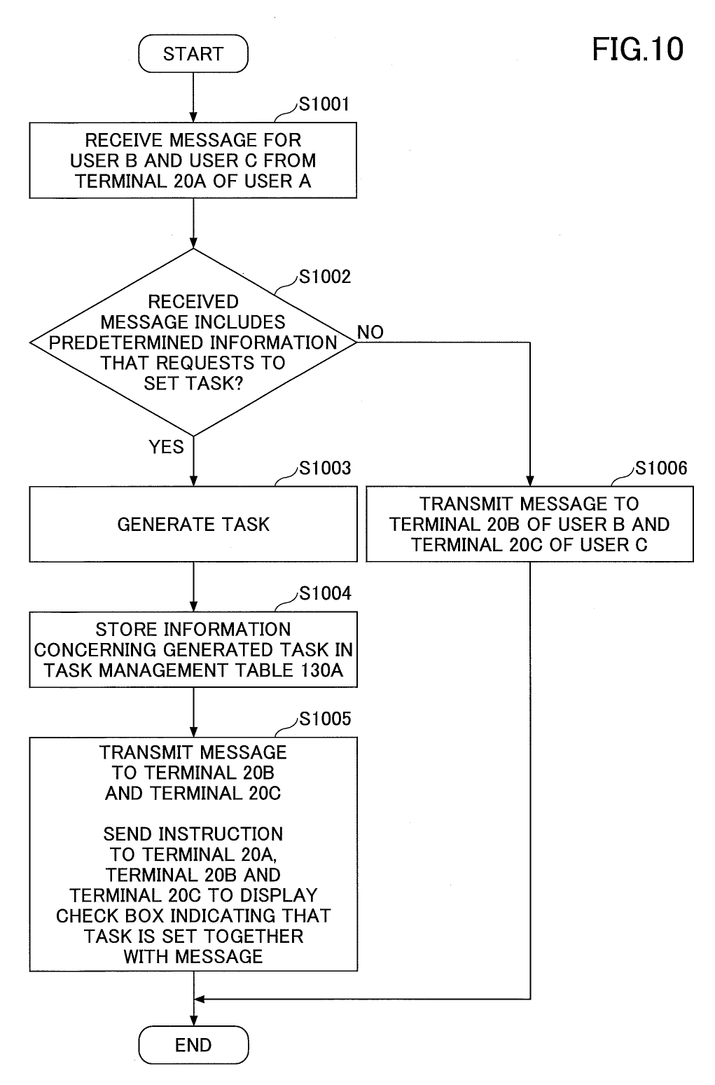

FIG. 10 illustrates one example of a flowchart of the information processing apparatus 10 concerning the operation sequence of FIG. 9. The flowchart of FIG. 10 illustrates operations that are carried out when the information processing apparatus 10 receives a message from the terminal 20.

In step S1001, the communications part 110 receives a message from the terminal 20A of the user A. The destinations of the message are assumed as the terminal 20B of the user B and the terminal 20C of the user C, who belong to a chat group.

In step S1002, the determination part 121 determines whether the received message includes the predetermined information that indicates a request to set a task. If the predetermined information is included there (YES in step S1002), the determination part 121 proceeds to step S1003. If the predetermined information is not included there (NO in step S1002), it proceeds to step S1006.

In step S1003, the task management part 125 receives an instruction from the determination part 121 to generate a task. If the predetermined. information indicates a part of the message, which is to be used as a name of the task, the task management part 125 determines a name of the task based on the predetermined. information.

In step S1004, the task management part 125 sends an instruction to the information storage part 130 to store information concerning the generated task in the task management table 130A. In response to receiving the instruction, the information. storage part 130 stores the information concerning the generated task in the task management table 130A.

In step S1005, the communications part 110 transmits the message to the terminal 20B of the user B and the terminal 20C of the user C, and sends an instruction to the terminals 20A, 20B and 20C of the users A, B and C to display the message together with a check box 50 that indicates that a task is set.

If the process proceeds to step S1006, the communications part 110 transmits the message to the terminal 20B of the user B and the terminal 20C of the user C in step S1006.

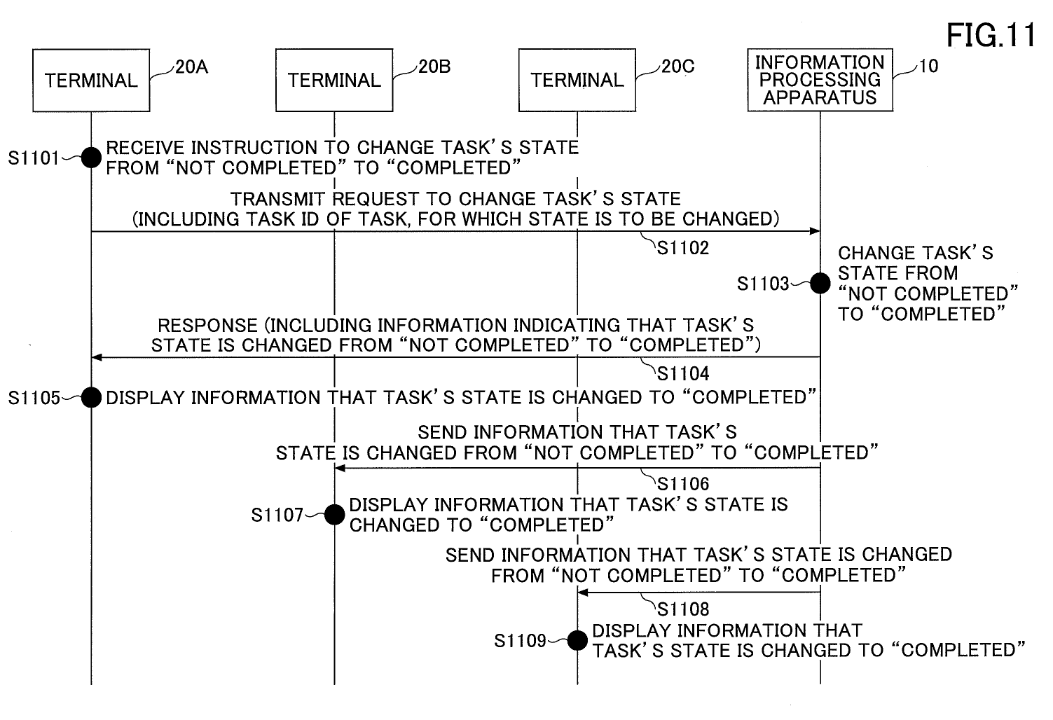

FIG. 11 is an operation sequence illustrating a task's state change according to the first embodiment.

In step S1101, the input part 230 of the terminal 20A receives from the user A an instruction to change the task's state of a task name “I buy XXX.” (task ID:AAA) from the state “not completed” to the state “completed”. The instruction from the user A can be received by checking the check box 50 in the chat message menu. Alternatively, the instruction from the user A can be received by checking the check box 35 in a state where the task list is displayed.

In step S1102, the communications part 110 of the terminal 20 transmits a task's state change request to the information processing apparatus 10. The task's state change request includes the task ID “AAA” for which the task's state is to be changed. The communications part 110 of the information processing apparatus 10 receives the task's state change request.

In step S1103, in response to the communications part 110 receiving the task's state change request, the task management part 125 of the information processing apparatus 10 sends an instruction to the information storage part 130 to change the task's state of the task ID “AAA” from. the state “not completed” to the state “completed”. In response to the information storage part 130 receiving the instruction, it changes the “state” field of the task ID “AAA” in the task management table 130A from the state “not completed” to the state “completed”. If the task is shared by the user A, the user B, and. the user C, the task's state identified by the task ID “AAA” in the respective task lists of the user A, the user B, and the user C are changed from the state “not completed” to the state “completed”.

In step S1104, the communications part 110 transmits a response to the task's state change request to the terminal 20A. The response includes information that the task's state is changed from the state “not completed” to the state “completed”. The communications part 210 of the terminal 20A receives the response.

In step S1105, the control part 240 of the terminal 20A. displays information that the task's state of the task ID “AAA” is changed to the state “completed” on the display part 220. The display part 220 displays information that the task's state of the task name “I buy XXX.” of the task ID “AAA” is changed to the state “completed” and the state change is performed by the user A.

In step S1106, the communications part 110 sends information to the terminal 20B that the task's state of the task ID “AAA” is changed. from the state “not completed” to the state “completed”.

In step S1107, the control part 240 of the terminal 20B displays information that the task's state of the task ID “AAA” is changed to the state “completed” on the display part 220. The display contents on the display part 220 are the same as those in step S1105.

In steps S1108 and S1109, the same processes as those of steps S1106 and S1107 are carried out in the terminal 20C.

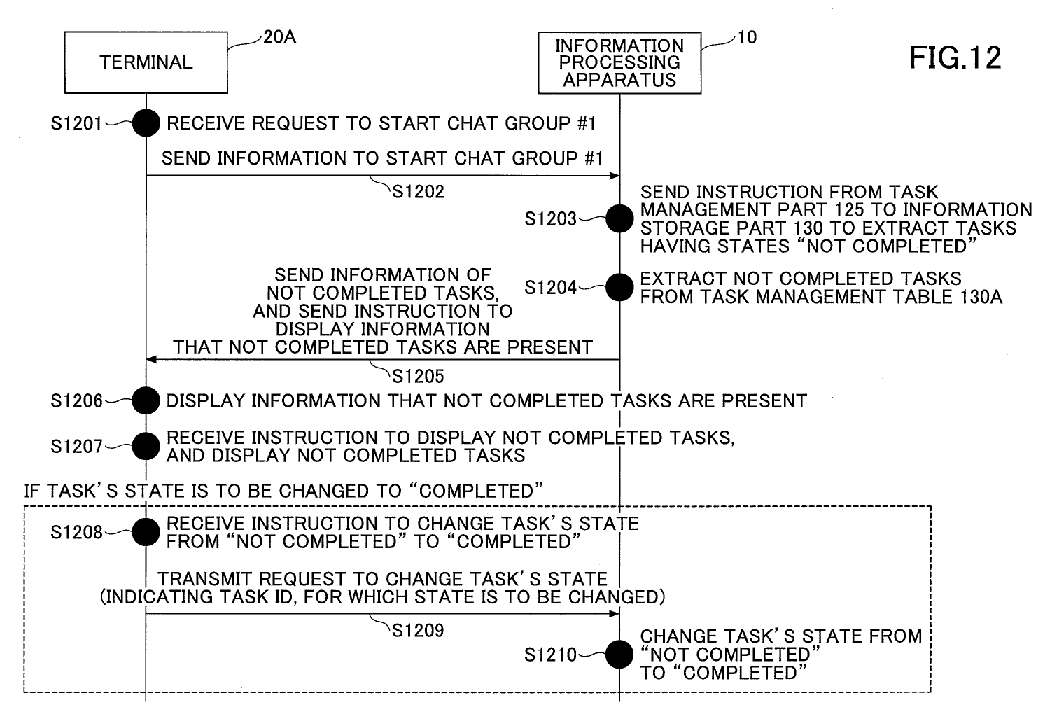

FIG. 12 illustrates an operation sequence of “not completed task” management.

In step S1201, the input part 230 of the terminal 20A receives a request to start a chat group 41 from the user A in the chat message menu. The user A, the user B, and the user C belong to the chat group #1.

In step S1202, the communications part 210 of the terminal 20A sends information that the chat group #1. is started to the information processing apparatus 10. The communications part 110 of the information processing apparatus 10 receives the sent information.

In step S1203, in response to the communications part 110 of the information processing apparatus 10 receiving the sent information, the task management part 125 sends an instruction to the information storage part 130 to extract the tasks that have the states “not completed” from among those shared by the user A, the user B, and the user C.

In step S1204, the information storage part 130 reads the task management table 130A, and extracts the tasks that have the states “not completed” from among those shared by the user A, the user B, and the user C. The information storage part 130 send information of the thus extracted tasks to the task management part 125.

In step S1205, the communications part 110 receives an instruction from the task management part 125 to send information of the not completed tasks thus extracted by the information storage part 130 to the terminal 20A, and sends an instruction thereto to display that the not completed tasks are present. The communications part 210 of the terminal 20A receives the information and the instruction from the information processing apparatus 10.

In step S1206, the control part 240 of the terminal 20A sends an instruction to the display part 220 to display that the not completed tasks are present.

In step S1207, if the input part 230 of the terminal 20A receives an instruction from the user A to display the not completed tasks, the control part 240 displays the not completed tasks on. the display part 220.

When the thus displayed not completed tasks' states are to be changed to the states “completed”, steps S1208-S1210 are carried out. These steps as the same as steps S1101-S1103, and therefore, the description is omitted.

With reference to FIG. 12, the operations have been described for the case where, when the chat group 41 is started, the not completed tasks are displayed. However, both the completed tasks and the not completed tasks can be displayed instead. Also, the users' tasks can be displayed in other timing.

For example, a list of a user's not completed tasks can be displayed on the display parts 220 of the user's terminal 20 when the chat message menu is started. Also, a user's all tasks, i.e., the completed tasks and the not completed tasks can be displayed on the display part 220 when the chat message menu is started.

### Screen Page Display

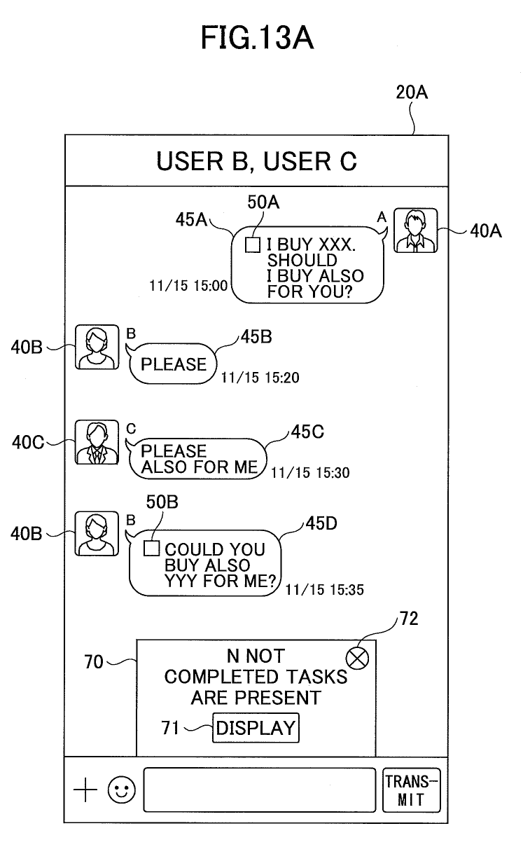

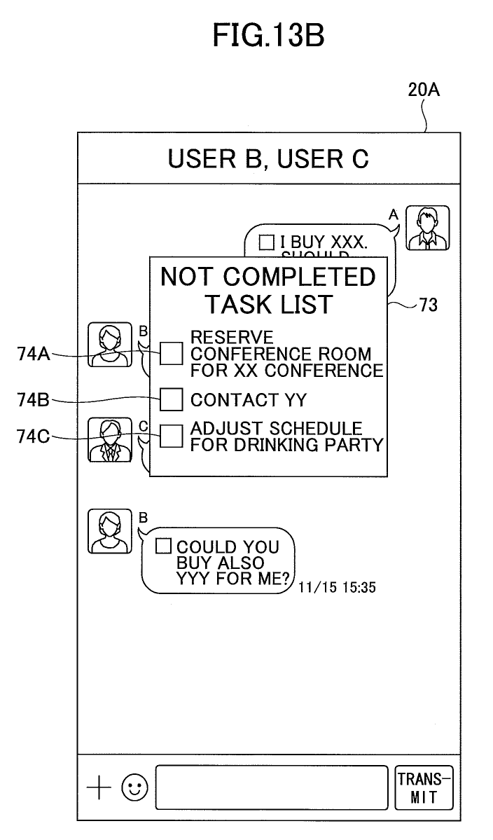

FIGS. 13A and 13B illustrate examples of display screen pages used of FIG. 12 are carried out.

FIG. 13A illustrates a display screen page displayed at the terminal 20A when a chat group is started in the chat message menu. If the tasks shared by the user A, the user B, and the user C, who belong to the chat group, include those of the states “not completed”, information 70 that not completed tasks are present is displayed on the display part 220. If the “display” button 71 is selected by the user, the display screen page of FIG. 13B is displayed. If the “X” button 72 is selected, a regular chat is started without displaying the display screen page of FIG. 13B.

FIG. 13B illustrates a state where the list of the not completed tasks (i.e., a “not completed task list”) is displayed. Via the display screen page of FIG. 13B, the terminal 20A can receive an instructor from the user to change a task's state. For example, if the input part 230 of the terminal 20A receives an instruction from the user of selecting the check box 74B, the task's state of the task “contact YY” is changed from the state “not completed” to the state “completed”.

### Second Embodiment

Next, a second embodiment will be described. Description concerning parts common with the first embodiment will be omitted, and description will be made concerning different parts.

### Summary of Second Embodiment

According to the second embodiment, in response to a change of a task's state from the state “not completed” to the state “completed”, a subsequent task setting operation is started.

There is a case where, in response a completion of a task, it is desirable to start a subsequent task setting operation. For example, after a task concerning purchase of an article is completed, a task concerning price settlement may occur. After a task “take child. to nursery” (i.e., to take a child to a nursery) is completed, a task “take child home from nursery” (i.e., to take the child home from the nursery) may occur.

According to the second embodiment, when the information processing apparatus 10 changes a task's state to the state “completed”, it determines whether a subsequent task is set for the task. in the task management table 130A. If a subsequent task is set, the information processing apparatus 10 causes the corresponding terminal 20 to start a subsequent task setting operation.

The information processing apparatus 10 can cause also the other terminal (s) 20, which share the same task, to start a subsequent task setting operation.

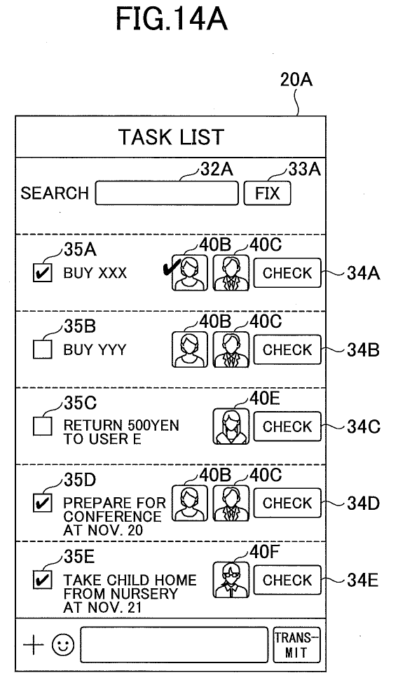

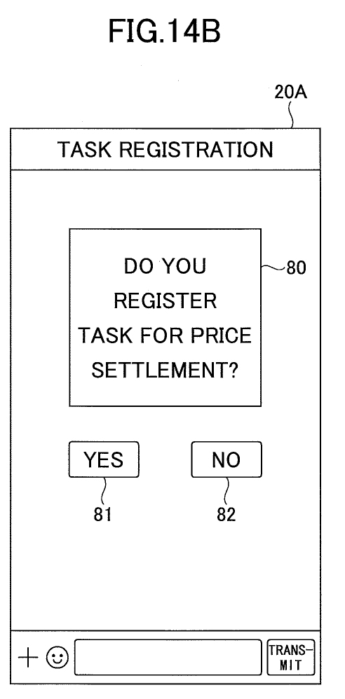

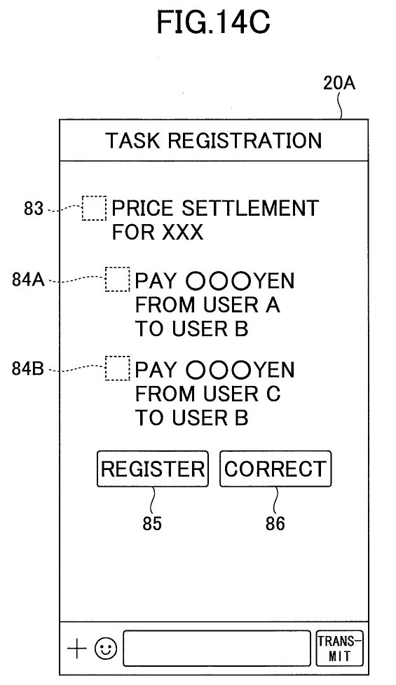

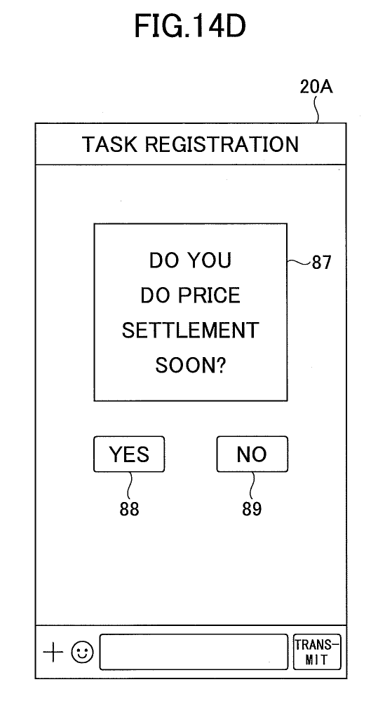

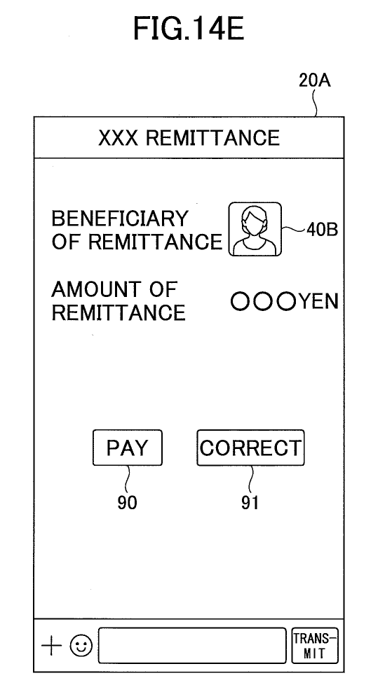

With reference to FIGS. 14A-14E, a subsequent task setting operation at a terminal 20 will be described. FIGS. 14A-14E illustrate examples of display screen pages at a terminal 20 according to the second embodiment.

FIG. 14A illustrates a state where, at the terminal 20A of the user A, information concerning a change in a task's state is displayed. That is, on the display part 220, a fact that the task's state of the task “I buy XXX.” is changed from the state “not completed” to the state “completed” is displayed. In FIG 14A, the icon 40B that represents the user B is checked, and this means that the terminal 20B receives an instruction from the user B to change the task's state.

FIG. 14B illustrates a state where, at the terminal 20A of the user A, a query as to whether to set a subsequent task is displayed. On the display part 220, a display screen page that includes a message 80 to query whether to register, as a subsequent task, a task “price settlement” is displayed. If the “YES” button 81 is selected. by the user A, a process to register a task for payment is started. If the “NO” button 82 is selected, no subsequent task is set, and the process is finished.

FIG. 14C illustrates a state where, at the terminal 20A of the user A, subsequent processes are displayed. In response to a corresponding input from the user A of the terminal 20A, a task that has a task name “price settlement for XXX” is set, as shown. In response to a corresponding input from the user A of the terminal 20A, as tasks (hereinafter, referred to as “subtasks”) that accompanies the task “price settlement for XXX”, a subtask “pay ◯◯◯ yen from user. A to user B”, and a subtask “pay ◯◯◯ yen from the user C to the user B” are set, as shown.

According to the second embodiment, a subtask can be set for a task. After all the subtasks' states are changed to the “completed” states, the task's state of the “task” is changed from the state “not completed” to the state “completed”.

For example, for a task concerning “price settlement”, subtasks of payments from respective members are set. After the subtasks concerning all the payments are completed, the task of price settlement is completed.

If the “register” button 85 is selected by the user in FIG. 14C, the task and the subtasks are registered in the information processing apparatus 10 based on a corresponding request for registration from the terminal 20A. If the “correct” button 86 selected, a display screen page for the user A to correct the task registration contents is displayed.

In response to the registration of the task and the subtasks concerning the “price settlement” task, a display screen page is displayed at the terminal 20A that indicates a query “do you do price settlement soon?”. FIG. 14D illustrates one example of the display screen page of the query 87. In the display screen page, if the “YES” button 88 is selected, a display screen page for a linked a remittance service is displayed. If the “NO” button 89 is selected, the process is finished.

FIG. 14E illustrates a state where the display screen page of the linked remittance service is displayed at the terminal 20A. As the beneficiary of remittance, the icon 40B of the user B is displayed. If the “pay” button 90 is selected, a remittance process is carried out. If the “correct” button 91 is selected, a display screen page for the user to correct the remittance contents is displayed. After the remittance process is completed, the subtask's state of the subtask “pay ◯◯◯ yen from user A to user B” is changed. from the state “not completed” to the state “completed”.

According to the second embodiment described above, in response to a change of a task's state to the state “completed”, registration of a subsequent task is started. Therefore, the task management becomes easier. Also, by setting a subtask, it is possible to know the execution state of the task. Thus, it is possible to avoid failing to carry out an essential action.

### Functional Configuration

### (1) Information Processing Apparatus

In order to generate an instruction to update a task's state, the task management part 125 reads the task management table 130B, and determines whether a subsequent task is set for the task. If a subsequent task is set, a message to query the corresponding terminal 20 as to whether to generate the subsequent task is transmitted via the communications part 110. For example, assuming that a task concerning purchase of an article is shared, a settlement may be needed among the users, who shares the task, after the purchase of the article is completed. Therefore, the task management part 125 transmits a message to query whether to generate a task concerning a settlement via the communications part 110 to the corresponding terminal 20.

The task management part 125 receives a request to change a subtask's state from the terminal 20 via the communications part 110, and, in response to the reception of the request, it sends an instruction to the information storage part 130 to update the subtask's state.

### (2) Task Management Table

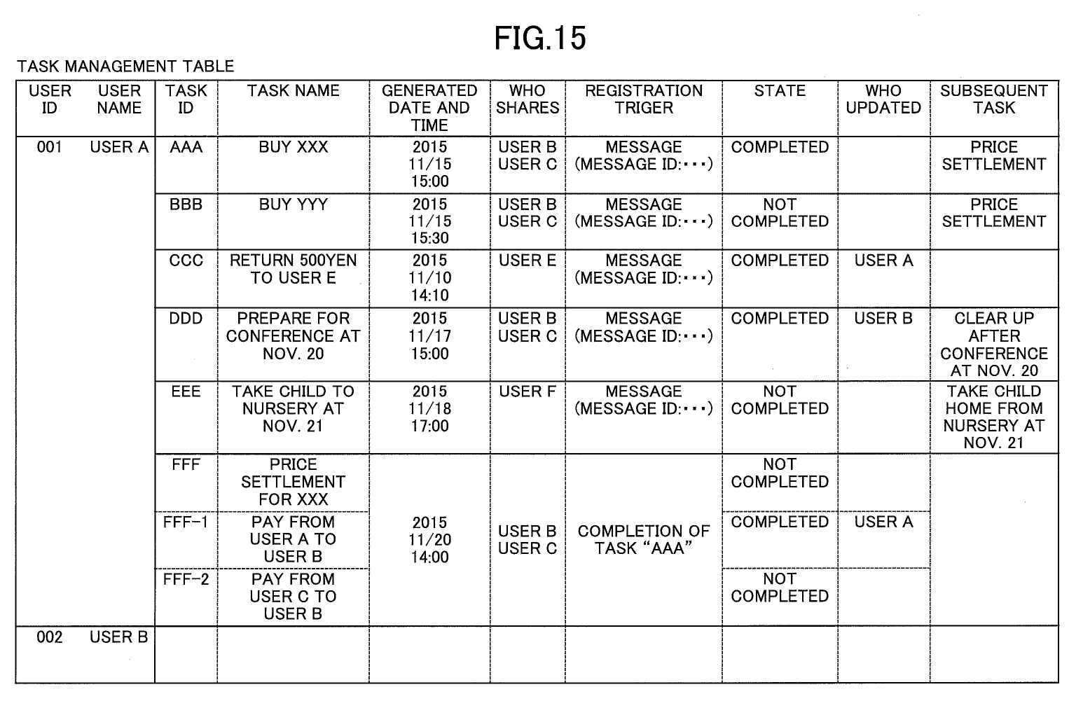

With reference to FIG. 15, the task. management table 130B according to the second embodiment will now be described. FIG. 15 illustrates one example of the task management table 130B according to the second embodiment. As shown, for each task, a subsequent task field is provided. In the subsequent task field, the task name of a task, which may be needed after the corresponding task is completed with high likelihood, is set. For example, as shown in FIG. 15, for a task concerning “purchase of an article”, a task “settlement” can be set in the subsequent task field. For a task concerning “prepare”, a task “clean up” can be set in the subsequent task field. For a task “take child to nursery”, a task “take child home from nursery” can be set in the subsequent task field. In the subsequent task field, the contents sent from the corresponding terminal 20 can be set, or a subsequent task estimated by the task management part 125 from the task name can be set.

In the task management table 130B, tasks and subtasks are stored in a manner of associating them with each other. For example, as the subtask of the task “price settlement for XXX” having the task ID “FFF”, shown in FIG. 15, the subtask “payment from user A to user B” having the task ID “FFF-1”, and the subtask “payment from user C to user B” having the task ID “FFF-2” are stored. The information storage part 130 receives information to change the subtask's state of each subtask, and, after the subtasks' states of all the subtasks that belong to a task are changed to the states “completed”, the information storage part 130 changes the task's state to the state “completed”.

### (3) Terminal

If the communications part 210 receives information concerning subsequent task from the information processing apparatus 10 after a task is completed, the display part 220 displays the received information concerning the subsequent task. The input part 230 then receives the user's input such as an instruction as to whether to register the subsequent task as well as setting items concerning the subsequent task if the subsequent task is to be registered.

### Operation Procedure

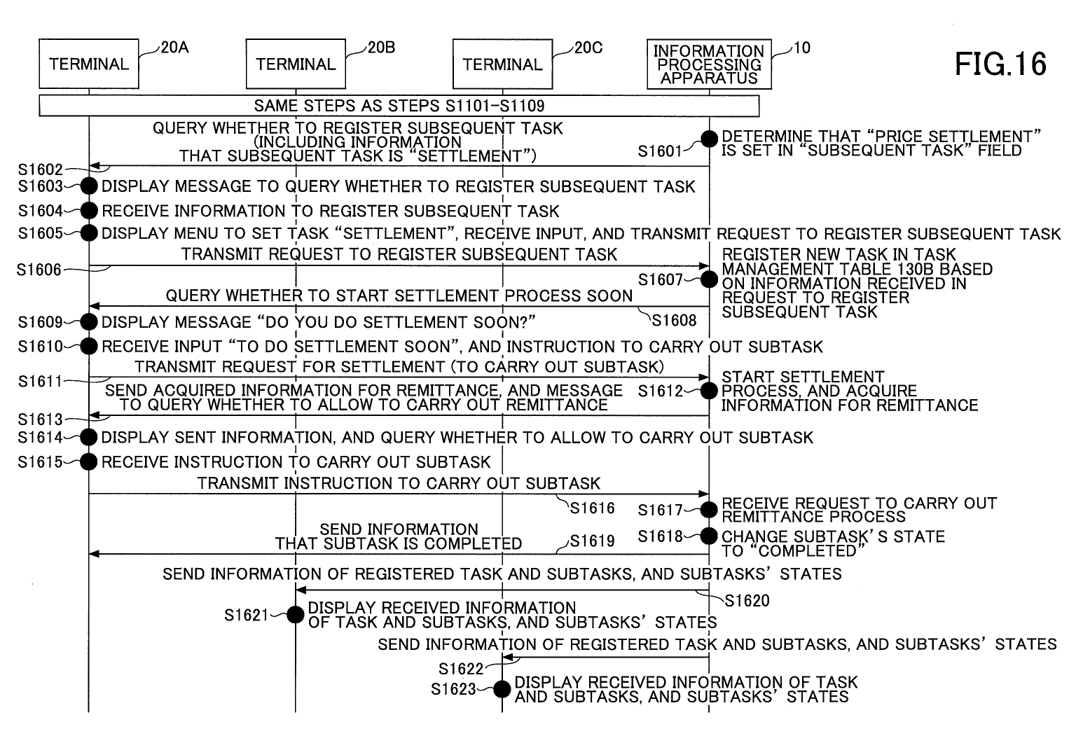

FIG. 16 illustrates one example of an operation procedure according to the second embodiment.

In FIG. 16, after steps S1101-S1109 of FIG. 11, the process starting from step S1601 is carried out. Through steps S1101-S1109, each terminal 20 finally receives information that a task's state is changed to the state “completed”.

For example, a case where the task's state of a task “I buy XXX.” is changed to the state “completed” will now be described.

In step S1601, the task management part 125 of the information processing apparatus 10 reads the task management table 130B, and determines therefrom that “settlement” is set in the “subsequent task” field for the Las “I buy XXX”.

In step S1602, the communications part 110 receives an instruction from the task management part 125, and queries the terminal 20A as to whether to register a subsequent task. The query includes information that the subsequent task is a task “settlement”. The communications part 210 of the terminal 20A receives the query.

In step S1603, the display part 220 of the terminal 20A. receives an instruction from the control part 240, and displays a message to query the user A as to whether to register the subsequent task.

In step S1604, the input part 230 of the terminal 20A receives information from the user A that registration of the subsequent task is necessary.

In step S1605, the control part 240 of the terminal 20A sends an instruction to the display part 220 to display a setting menu for the user to set the task “settlement”. The display part 220 displays the setting menu for the task “settlement”. The input part 230 then receives from. the user A concerning the “settlement” task and a corresponding subtask(s). In this case, for example, the task name “price settlement for XXX” is input by the user, and the subtask names “pay ◯◯◯ yen from user A to user B” and “pay ◯◯◯ yen from user C to user B” are input as information to determine the payers, the payment recipient and the payment amounts.

In step S1606, the communications part 210 of the terminal 20A receives an instruction from the control part 240, and transmits a subsequent task registration request to the information processing apparatus 10. The subsequent task registration request includes the task name, and the information of the payers, the payment recipient and the payment amounts that are input in step S1605. The communications part 110 of the information processing apparatus 10 receives the subsequent task registration request.

In step S1607, in response to the reception of the subsequent task registration request, the task management part 125 registers the corresponding new tasks in the task management table 130B based on the information included in the subsequent task registration request.

In step S1608, the task management part 125 queries the terminal 20A as to whether to start the “settlement” process soon, via the communications part 110. The communications part 210 of the terminal 20 receives the query.

In step S1609, the control part 240 displays a message “do you do price settlement soon”, on the display part 220.

In step S1610, the input part 230 receives from the user an input. “to do price settlement soon” and an instruction to carry out the subtask “pay ◯◯◯ yen from user A to user B”.

In step S1611, the communications part 210 transmits a “settlement” request. The information processing apparatus 10 receives the “settlement” request. The “settlement” request includes a request to carry out the subtask “pay ◯◯◯ yen from user A to user B”.

In step S1612, in response to reception of the “settlement” request, the control part 120 starts a “settlement” process. Actually, the control part 120 acquires transfer origin information (for example, an account of the user A and the balance of the account) and transfer destination information (for example, an account of the user B) to carry out the remittance of the subtask “payment of ◯◯◯ yen from user A to user B”.

In step S1613, the communications part 110 of the information processing apparatus 10 sends the thus acquired transfer origin information and the transfer destination information to the terminal 20A. The communications part 110 of the information processing apparatus 10 also queries the terminal 20A as to whether to allow to carry out the remittance, at the same time. The communications part 210 of the terminal 20A receives the sent information.

In step S1614, based on an instruction of the control part 240, the display part 220 of the terminal 20A displays the information thus sent from the information processing apparatus 10, and a display a message to urge the user to select as to whether to allow to carry out the subtask “payment of ◯◯◯ yen from user A to user B”.

In step S1615, the input cart 230 of the terminal 20A receives an instruction to carry out the subtask.

In step S1616, the communications part 210 of the terminal 20A. transmits the instruction to carry out the subtask to the information processing apparatus 10. The communications part 110 of the information processing apparatus 10 receives the instruction to carry out the subtask.

In step S1617, the control part 120 of the information processing' apparatus 10 receives a request to carry out the remittance process of the subtask “payment of ◯◯◯ yen from user A to user B”. The remittance process will be carried out in predetermined timing.

In step S1618, in response to reception of the request to carry out the remittance process, the task management part 125 changes the subtask's state of the subtask “payment of ◯◯◯ yen from user A to user B” to the state “completed”. Alternatively, the change of the subtask's state of the subtask to the state “completed” can be carried out at the time of the completion of the remittance process.

In step S1619, the communications part 110 of the information processing apparatus 10 sends information that the subtask is completed to the terminal 20A.

In step S1620, the communications part 110 of the information processing apparatus 10 sends information of the task and the subtasks thus registered in response to the corresponding task registration request from the terminal 20A of the user A, and the subtasks' states, to the terminal 20B of the user B. The communications part 210 of the terminal 20B receives the sent information.

In step S1621, the display part 220 of the terminal 20B displays the sent information of the task, the subtasks, and the subtasks' states, based on corresponding instructions from the control part 240.

In steps S1622 and S1623, the same processes, as those of steps S1620 and S1621, are carried out also at the terminal 20C of the user C.

The registration of the “subsequent task” can be carried out from any one of the terminals 20A, 20B, and 20C. The process of sending the information of the registered tasks, and so forth, to the terminals 20B and 200 can be carried out at any timing after step S1607.

Thus, as an example of setting a subsequent task, the remittance process has been described. However, the same or similar procedure can be applied also to setting any other subsequent task.

### Others

In the above-described embodiments, the information processing apparatus 10 determines whether a message includes the predetermined information, and, if the predetermined information is included there, carries out a process of setting a task. Alternatively, the process of determining whether a message includes tie predetermined information can be carried out at a terminal 20, to which the message is input by the user.

In the above-described embodiments, as tasks' states, the state “completed” and the state “not completed” are set, as described above. However, any other states can be set. For ax ample, a state “currently being carried out” can be set.

The information processing apparatus 10 is one example of an information processing apparatus. The respective functions of the information processing apparatus 10 can be implemented by a separate hardware unit(s). In this case, the functions of the information processing apparatus 10 are implemented as a result of the functions thus implemented by the separate hardware unit(s) operating together. For example, the information processing apparatus 10 can acquire information from. the information storage part 130 that is implemented by another apparatus, and carry out the above-described operations.

The task management part 125 is one example of a device that generates a task. The communications part 110 is one example of a device that transmits information indicating a generated task. The communications part 210 is one example of a device that transmits information indicating a generated task and a device that receives information indicating that a task's state is updated.

Storage media that store program codes configured to implement the above-described functions of the embodiments can be supplied to the information processing apparatus 10 and the terminals 20. Then, the above-described embodiments can be implemented as a result of the information processing apparatus 10 and the terminals 20 reading the program codes from the storage media and executing them. In this case, the storage media store programs configured to cause the information processing apparatus 10 and the terminals 20 to carry out the above-described task management methods.

Actually, a storage medium stores a program configured to cause the terminal 20A to carry out transmitting a message for the terminal 20B that includes the predetermined information that indicates a request to generate a task; receiving information of the task, generated in response to the message and shared with the terminal 20B; and displaying the task's state updated in response to an. input that is performed on the terminal 20B.

Also, a storage medium stores a program configured to cause the information processing apparatus 10 to carry out determining whether a message received from the terminal 20A includes the predetermined information; generating a task if the predetermined information is included there; transmitting information of the task to the terminal 20A and the terminal 20B, which is the transmitting destination of the message; and managing the updated task's state if the task's state is updated in response to an input being performed on the terminal 20A or the terminal 20B.

The program codes themselves that are read from the storage media implement the above-described embodiments.

An actual method for implementing the above-described embodiments is not limited to the method where program codes read by a computer device are executed by the computer device. An Operating System (OS) or the like that operates in the computer device can carry out a part or all of the actual processes according to the instructions of the program codes. In this case, a function(s) of the above-described embodiments can be implemented by the thus carried out process(es).

According to the embodiments, it is possible to extract, as a task, the contents to be managed among terminals that are performing communications, share the task's state of the thus extracted task by the users of the terminals, and manage the task's state.

Thus, the task management methods, the terminals, and the non-transitory computer-readable information recording media have been described in the embodiments. However, embodiments are not limited to these embodiments. Various modifications and/or improvements such as combinations with part or all of another embodiment(s), a replacement (s) with part of another embodiment(s), and so forth, can be made.

What is claimed is:

1. A task management method carried out by one or more processors, the task management method comprising:
determining whether a message received from a first terminal includes predetermined information;
generating a task if the message includes the predetermined information;
transmitting information of the generated task to the first terminal and a second terminal that is a transmitting destination of the message; and
receiving information to update the task's state from the first terminal or the second terminal, and managing the task's state.

2. The task management method as claimed in claim 1, further comprising:
storing the information of the generated task for being shared by a user of the first terminal and a user of the second terminal.

3. The task management method as claimed in claim 2, further comprising:
when communications are started between the first terminal and the second terminal, displaying the task's state on the first terminal or the second terminal, the information of which is stored for being shared by the user of the first terminal and the user of the second terminal.

4. The task management method as claimed in claim 1, further comprising:
if the task's state is updated, displaying on the first terminal and the second terminal information that the task's state is updated in such a manner that the information that the task's state is updated is associated with the user, who requests to update the task's state.

5. The task management method as claimed in claim 2, further comprising:
if the task's state is updated, displaying on the first terminal and the second terminal information that the task's state is updated in such a manner that the information that the task's state is updated is associated with the user, who requests to update the task's state.

6. The task management method as claimed in claim 3, further comprising:
if the task's state is updated, displaying on the first terminal and the second terminal information that the task's state is updated in such a manner that the information that the task's state is updated is associated with the user, who requests to update the task's state.

7. The task management method as claimed in claim 1, further comprising:
in response to the task's state being updated. to a state of being completed, displaying on at least one of the first terminal and the second terminal a message to determine whether to register a task subsequent to the task, for which the task's state is updated to the state of being completed.

8. The task management method as claimed in claim 2, further comprising:
in response to the task's state being updated to a state of being completed, displaying on at least one of the first terminal and the second terminal a message to determine whether to register a task subsequent to the task, for which the task's state is updated to the state of being completed.

9. The task management method as claimed in claim 3, further comprising:
in response to the task's state being updated to a state of being completed, displaying on at least one of the first terminal and the second terminal a message to determine whether to register a task subsequent to the task, for which the task's state is updated to the state of being completed.

10. The task management method as claimed in claim 4, further comprising:
in response to the task's state being updated to a state of being completed, displaying on at least one of the first terminal and the second terminal a message to determine whether to register a task subsequent to the task, for which the task's state is updated to the state of being completed.

11. The task management method as claimed in claim 5, further comprising:
in response to the task's state being updated to a state of being completed, displaying on at least one of the first terminal and the second terminal a message to determine whether to register a task subsequent to the task, for which the task's state is updated to the state of being completed.

12. The task management method. as claimed in claim 6, further comprising:
in response to the task's state being updated to a state of being completed, displaying on at least one of the first terminal and the second terminal a message to determine whether to register a task subsequent to the task, for which the task's state is updated to the state of being completed.

13. The task management method as claimed in claim 7, further comprising:
in response to the task's state being updated to the state of being completed, starting a process in at least one of the first terminal and the second terminal to register a task concerning a settlement as the task subsequent to the task, for which the task's state is updated to the state of being completed, if the settlement is needed between the users who share the task, for which the task's state is updated to the state of being completed.

14. The task management method as claimed in claim 1, wherein
the generated task includes a plurality of subtasks, which are associated with the task, and the task management method further comprising:
if the respective subtasks' states are updated to states of being completed, updating the task's state to a state of being completed.

15. The task management method as claimed in claim 1, wherein
the predetermined information is a predetermined character, a predetermined character string, a predetermined sign, a predetermined code, a predetermined mark, or any combination thereof.

16. The task management method as claimed. in claim 1, further comprising:
generating a name of the task with reference to the predetermined information. and the message.

17. A terminal, which comprises one or more processors, the one or more processors being configured to:
transmit a message for another terminal, the message including predetermined information that indicates a request to generate a task;
receive information. of the task that is generated in response to the message and is shared with the other terminal; and
display the task's state that is updated in response to an input being performed on the other terminal.

18. A non-transitory computer-readable information recording medium that stores a computer-executable program, which causes at least one processor to:
determine whether a message received from a first terminal includes predetermined information;
generate a task if the message includes the predetermined information;
transmit information of the generated task to the first terminal and a second terminal that is a transmitting destination of the message; and
if the task's state is updated in response to an input being performed on the first terminal or the second terminal, manage the updated task's state.
